(19) United States
(12) Patent Application Publication
(10) Pub. No.: US 2016/0148270 A1
(43) Pub. Date: May 26, 2016

(54) Campaign Management Systems for Creating and Managing Beacon Based Campaigns

(71) Applicant: Apple Inc., Cupertino, CA (US)

(72) Inventors: Benjamin Vigier, San Francisco, CA (US); Corey G. Fugman, Saratoga, CA (US); Filip Krsmanovic, Mountain View, CA (US); Yingfeng Su, Sunnyvale, CA (US)

(21) Appl. No.: 14/679,680

(22) Filed: Apr. 6, 2015

Related U.S. Application Data
(60) Provisional application No. 62/085,216, filed on Nov. 26, 2014.

(51) Int. Cl. G06Q 30/02; H04H 20/61

(52) U.S. Cl. CPC G06Q 30/0267; G06Q 30/0261; H04H 20/61

(57) ABSTRACT

Techniques and systems for beacon based campaign creation and management are disclosed. A disclosed technique includes providing a graphical user interface to create a campaign zone for a location, create campaign messages for the campaign zone, prioritize the campaign messages, and produce campaign message priority information; generating campaign information based on the campaign messages and the campaign message priority information; and providing the campaign information to mobile devices. The graphical user interface can be configured to specify for a campaign message a beacon identifier associated with a beacon device that is within a vicinity of the location, and to specify for the campaign message an action for a mobile device to perform in response to receiving a beacon message containing the beacon identifier from the beacon device.

### CROSS REFERENCE TO RELATED APPLICATION

This patent document claims the benefit of the priority of U.S. Provisional Patent Application No. 62/085,216, filed on Nov. 26, 2014. The above-identified application is incorporated herein by reference in its entirety.

### TECHNICAL FIELD

This disclosure relates generally to radio frequency (RF) beacons.

### BACKGROUND

Many modern mobile devices (e.g., a smart phone, tablet computer, wearable computer) include one or more radio frequency receivers, transmitters, or transceivers that allow one-way or two-way communications with other devices. For example, a mobile device can use a transceiver to communicate with a server on the Internet via a base station of a wireless network. In another example, a mobile device can include a receiver to receive low powered RF signals from devices such as RF beacons.

### SUMMARY

Techniques and systems for beacon based campaign creation and management are disclosed. A campaign management system can provide one or more interfaces for creating and managing campaigns associated with beacon devices of one or more locations such as areas or establishments, e.g., retail stores, service providers, stadiums, museums, or airports. These campaigns can offer an interactive experience within the establishments by controlling how mobile devices respond to RF signals from the beacon devices. The campaign management system can create campaign zones for respective establishments, and further create campaign messages within each of the campaign zones. The system can provide an interface to create mappings between campaign messages and beacon messages of respective beacon devices. In some implementations, a beacon message includes a message value, and a campaign message provides a human friendly message that corresponds to the message value.

An application running on a mobile device can be configured to receive beacon messages and campaign information including campaign messages and rules. The application can use the campaign information to intelligently prioritize a presentation of campaign messages that correspond to the received beacon messages through the mobile device. In what follows, presenting a received beacon message can include displaying a campaign message that corresponds to a received beacon message. In some implementations, received beacon messages can be presented by a user's mobile device based on one or more rule sets, priority preferences, priority configurations, and contexts generally based on proximity of the mobile device to beacon devices, user or environment context, timing, message frequency, inter-beacon border rules and the like. For example, in a beacon-equipped retail store an initial “welcome to the store” beacon message may be repeatedly received by a customer's mobile device from a beacon device near a store entrance, but is desired by the store operator to be displayed on the mobile device only once in a given time period (e.g., once per day) so as not to annoy the customer with redundant displays of the same welcome message.

When the customer walks through a beacon-equipped establishment with a mobile device, beacon messages broadcast from beacon devices throughout the establishment can be received and prioritized by an application or operating system running on the user's mobile device and based on the prioritization are selectively presented (e.g., displayed) through the mobile device. Message priority can be determined based on one or more factors. In some implementations, message priority can be based on proximity to a beacon device; where messages broadcast from nearby beacon devices have a higher priority than messages broadcast from beacon devices farther away. In some implementations, message priority can be determined based on context such as a user's reason for visiting the establishment. In some implementations, a message priority can be determined based on context and proximity. Context information can include a user's activities before arriving to the establishment (e.g., ordered a product to pick-up, scheduled an in-store consultation, scheduled a repair drop-off/pick-up) or what a user is doing while in the establishment (e.g., the type of mobile device being used, the type of device the user is interacting with) can be used to determine message priority.

In some implementations, message priority can be based on inter-beacon border rules. For example, if a user's mobile device is receiving messages from more than one beacon device then inter-beacon border rules can be used to determine which beacon message to present first. Some implementations can use priority “stickiness” to determine how to prioritize the presentation of competing beacon messages. For example, if a user's mobile device is receiving a signal from a first beacon device and someone walks between the mobile device and the first beacon device, the signal from that first beacon device may become weaker than a signal from a second beacon device. Instead of immediately switching to displaying beacon messages from the second beacon device, an application or operating system running on the mobile device determines whether to present messages from the second beacon device rather than messages from the first beacon device. The decision can be based on length of time the signal strength dropped, the magnitude of the change in signal strength, and/or other factors and contexts.

In some implementations, message priority can be based on a history of previously presented messages, including tracking a number of times a message has been presented to a mobile device user. For example, if a beacon message has already been presented, then the beacon message should not be presented again unless there is an overriding factor present, e.g., new day, phone reset, retail store application restart, etc. Beacon devices can continuously broadcast the same message throughout the day or can alternate among a group of messages. An application on a mobile device can filter the beacon messages and only present one or more pertinent messages which are based on the determined message priority. The application or operating system of the mobile device can dynamically update message priorities based on continuously changing information such as changes in a received signal strength indicator (RSSI) due to the user moving about in the store.

In some implementations, an application or operating system can run a background process that monitors for beacon messages while the mobile device is in an idle state or while the screen of the mobile device is powered-off. The application or operating system can determine whether to wake the mobile device and display a received beacon message. However, if too many beacon messages are received by the mobile device and the mobile device is continually waking up to process the beacon messages, significant drain on the mobile device battery may occur. For example, if the mobile device user works in a mall, the user may frequently pass by a beacon-equipped store throughout the day and the user's mobile device may wake up each time the user passes the store due to proximity of the mobile device to a beacon device in the store. This and other scenarios can be mitigated by using a smart wake-up process, where the application or operating system of the mobile device can be configured to manage the frequency of wake-ups by determining a priority value that accounts for wake-up frequency and context. In some implementations, the priority value is based on how many times the mobile device has awakened within a time period (e.g., minute(s), hour(s), or day(s)).

In some implementations, a beacon based campaign management technique can include providing, by a data processing apparatus, a graphical user interface to create a campaign zone for a location, create campaign messages for the campaign zone, prioritize the campaign messages, and produce campaign message priority information; generating, by the data processing apparatus, campaign information based on the campaign messages and the campaign message priority information; and providing, by the data processing apparatus, the campaign information to mobile devices. The graphical user interface can be configured to specify for a campaign message a beacon identifier associated with a beacon device that is within a vicinity of the location, and to specify for the campaign message an action for a mobile device to perform in response to receiving a beacon message containing the beacon identifier from the beacon device. Other implementations are directed to systems, devices and computer-readable, storage mediums.

These and other implementations can include one or more of the following features. Providing the campaign information to mobile devices can include sending the campaign information to an application running on the mobile device. In some implementations, the campaign information controls how the application presents one or more of the campaign messages in response to receiving one or more beacon messages that are associated with the campaign zone. In some implementations, the campaign information controls a presentation order of two or more of the campaign messages in response to receiving multiple different beacon messages that are associated with the campaign zone. The graphical user interface can include an interface to specify for the campaign message one or more first level criteria for determining whether to present a campaign message parameter. In some implementations, the campaign message priority information can include one or more second level criteria to resolve a tie if two or more of the campaign messages qualify for presentation based on respective one or more first level criteria. Campaign information can include one or more campaign message records. A campaign message record can include one or more of the following: a beacon identifier parameter corresponding to the beacon identifier, an action type parameter corresponding to the action, a proximity threshold parameter, message frequency parameter, or message content parameter. Implementations can include receiving campaign zone information from a mobile device; identifying a campaign zone that corresponds to the campaign zone information; retrieving campaign information corresponding to the identified campaign zone; and sending the retrieved campaign information to the mobile device. In some implementations, the campaign zone information can include a detected beacon identifier that is detected by the mobile device. In some implementations, the campaign zone information can include location information based on a geographical location of the mobile device.

In some implementations, a beacon based campaign management technique can include providing an interface to create a campaign zone for an establishment; providing a campaign message interface to create campaign messages for the campaign zone, the campaign message interface including a first interface to specify for a campaign message a beacon identifier associated with a beacon device that is within a vicinity of the establishment, and a second interface to specify for the campaign message an action for a mobile device to perform in response to receiving a beacon message containing the beacon identifier from the beacon device; providing an interface to prioritize the campaign messages and to produce campaign message priority information; generating campaign information based on the campaign messages and the campaign message priority information; and providing the campaign information to mobile devices. Other implementations are directed to systems, devices and computer-readable, storage mediums.

A system can include a processor and a memory structure coupled with the processor, the memory structure being configured to store campaign related data. The processor can be configured to perform operations including providing an interface to create a campaign zone for an establishment; providing a campaign message interface to create campaign messages for the campaign zone, the campaign message interface including a first interface to specify for a campaign message a beacon identifier associated with a beacon device that is within a vicinity of the establishment, and a second interface to specify for the campaign message an action for a mobile device to perform in response to receiving a beacon message containing the beacon identifier from the beacon device; providing an interface to prioritize the campaign messages and to produce campaign message priority information; generating campaign information based on the campaign messages and the campaign message priority information; storing the campaign information in the memory structure; and providing the campaign information to the mobile devices.

In some implementations, the processor can be configured to perform operations including providing a graphical user interface to create a campaign zone for a location, create campaign messages for the campaign zone, prioritize the campaign messages, and produce campaign message priority information; generating campaign information based on the campaign messages and the campaign message priority information; storing the campaign information in the memory structure; and providing the campaign information to mobile devices. The graphical user interface can be configured to specify for a campaign message a beacon identifier associated with a beacon device that is within a vicinity of the location, and to specify for the campaign message an action for a mobile device to perform in response to receiving a beacon message containing the beacon identifier from the beacon device.

A mobile device can be configured to use campaign information. For example, a mobile device can be configured to perform operations that include determining campaign zone information associated with a location; sending, from the mobile device, the campaign zone information to a server; receiving a campaign file that corresponds to the campaign zone information, the campaign file including campaign messages; receiving beacon messages from multiple beacon devices over short-range communication links, the beacon devices being within a vicinity of the location; determining priorities of the beacon messages based on the campaign file; selecting a beacon message of the beacon messages based on the priorities to produce a selected beacon message; and presenting a campaign message of the campaign messages that corresponds to the selected beacon message through the mobile device. The campaign zone information can include a detected beacon identifier that is detected by the mobile device. The campaign zone information can include location information based on a geographical location of the mobile device. The mobile device can include circuitry configured to receive beacon messages from multiple beacon devices over short-range communication links.

Particular implementations disclosed herein provide one or more of the following advantages. A management campaign system can be used to efficiently manage mobile device interactions with dozens, hundreds, thousands, or more of beacon devices. Further, a nation wide or international chain of establishments, for example, can periodically and dynamically push out new campaigns, e.g., new campaign messages, without the need to reprogram beacon devices. In other words, while beacon messages and their associated beacon messages remain the same, the new campaign can provide a different “translation” for the beacon messages.

The details of the disclosed implementations are set forth in the accompanying drawings and the description below. Other features, objects and advantages are apparent from the description, drawings and claims.

### DESCRIPTION OF DRAWINGS

FIG. 1 is a plan view of an example operating environment that includes a beacon-based campaign management system for creating and managing campaigns at beacon-equipped establishments.

FIG. 2 is a plan view of an example operating environment of a beacon-equipped establishment.

FIG. 3 illustrates a layout of an example graphical user interface for a campaign creation and management engine.

FIG. 4 illustrates an example process performed by a campaign management system.

FIG. 5 illustrates an example operating environment for beacon-based campaigns.

FIG. 6 illustrates a high level architecture of an example mobile device.

FIG. 7 illustrates an example process performed by a mobile device to process beacon messages and associated campaigns.

FIG. 8 illustrates another example process performed by a mobile device to process beacon messages and associated campaigns.

FIGS. 9A, 9B, and 9C illustrate different examples of beacon message formats.

FIG. 10 is a block diagram of an example mobile device architecture.

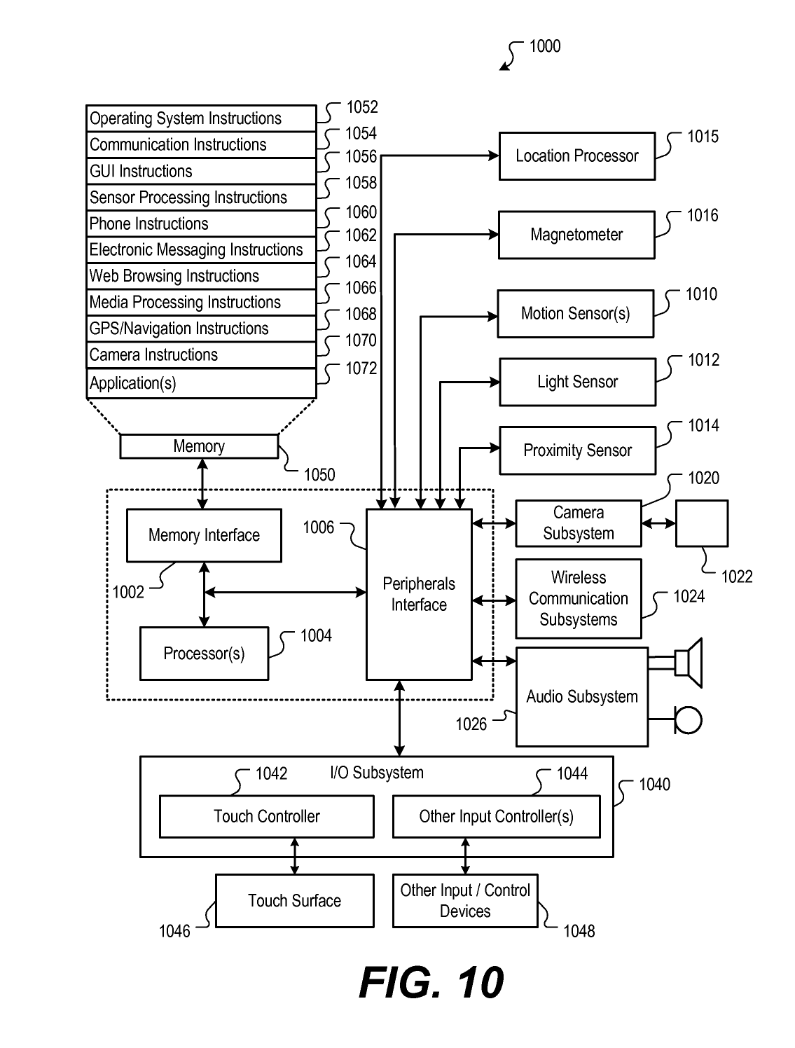

The same reference symbol used in various drawings indicates like elements.

### DETAILED DESCRIPTION

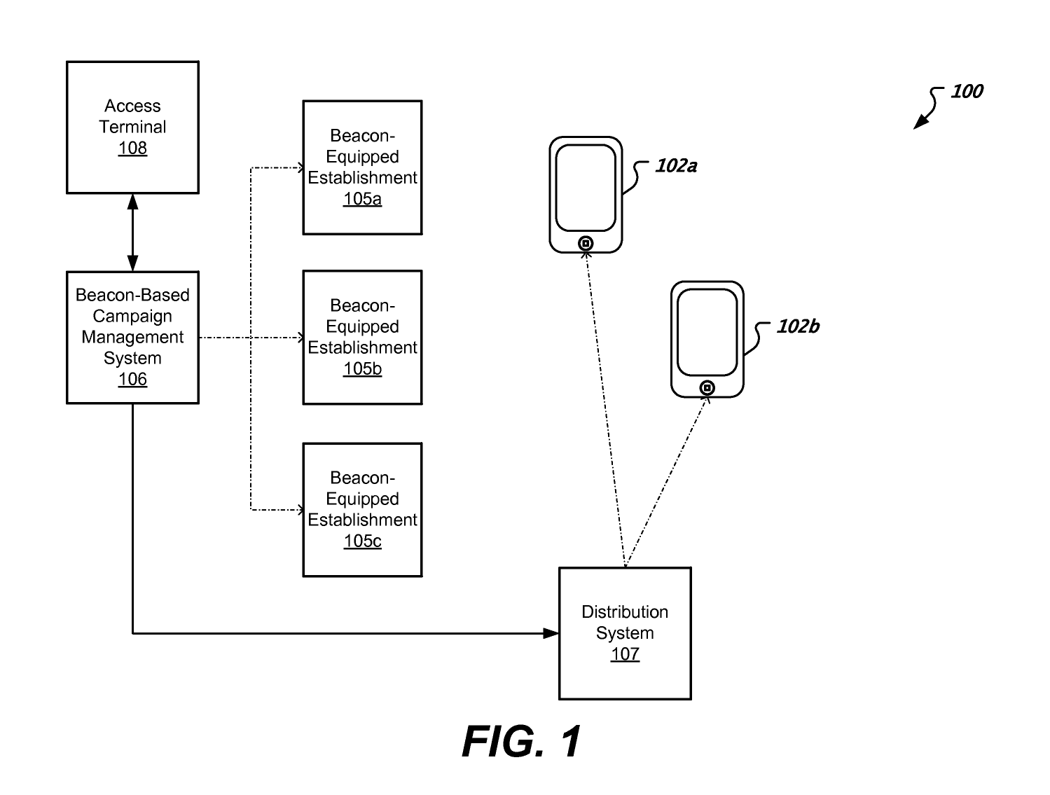

FIG. 1 is a plan view of an example operating environment 100 that includes a beacon-based campaign management system 106 for creating and managing campaigns at beacon-equipped establishments 105a-c. Various examples of establishments 105a-c include retail stores, service providers, restaurants, museums, airports, sports arenas, and the like. Other types of establishments are possible. Establishment operators can provide an interactive experience to patrons through their mobile devices 102a-b by creating campaigns on the campaign management system 106 that control how mobile devices 102a-b react to receiving beacon messages from beacon devices within the establishments 105a-c. For example, the establishments 105a-c can include beacon devices that broadcast beacon messages to mobile devices 102a-b using short-range communication links. After receiving a beacon message, the mobile devices 102a-b can present a campaign message that corresponds to the received beacon message.

To manage the interactive experience, the beacon-based campaign management system 106 can create and manage campaigns at beacon-equipped establishments 105a-c to control how the mobile devices 102a-b react to received encountered beacon messages. In some implementations, the campaign management system 106 can create content associated with the beacon message and create message priority and presentation rules that control how and when content is presented on the mobile devices 102a-b. An access terminal 108, such as a desktop computer, laptop, tablet, or smartphone, can provide access to the campaign management system 106. In some implementations, the campaign management system 106 provides a web-based beacon-based campaign management engine. A web browser running on the access terminal 108 can access the beacon-based campaign management engine of the system 106 via a network such as the Internet. The campaign management system 106 can create campaign information for each of the beacon-equipped establishments 105a-c. Campaign information can include campaign message records that provide content (e.g., video, audio, text, uniform resource locator (URL), etc.), message priority rules, presentation rules, or a combination thereof. Other types of campaign information are possible.

The campaign management system 106 can send campaign information to a distribution system 107. The distribution system 107 can distribute campaign information to devices such as mobile devices 102a-b. An application running on the mobile devices 102a-b can process the campaign information to provide an interactive experience within the establishments 105a-c. In some implementations, the campaign management system 106 includes the distribution system 107. The systems 106, 107 can include one or more servers.

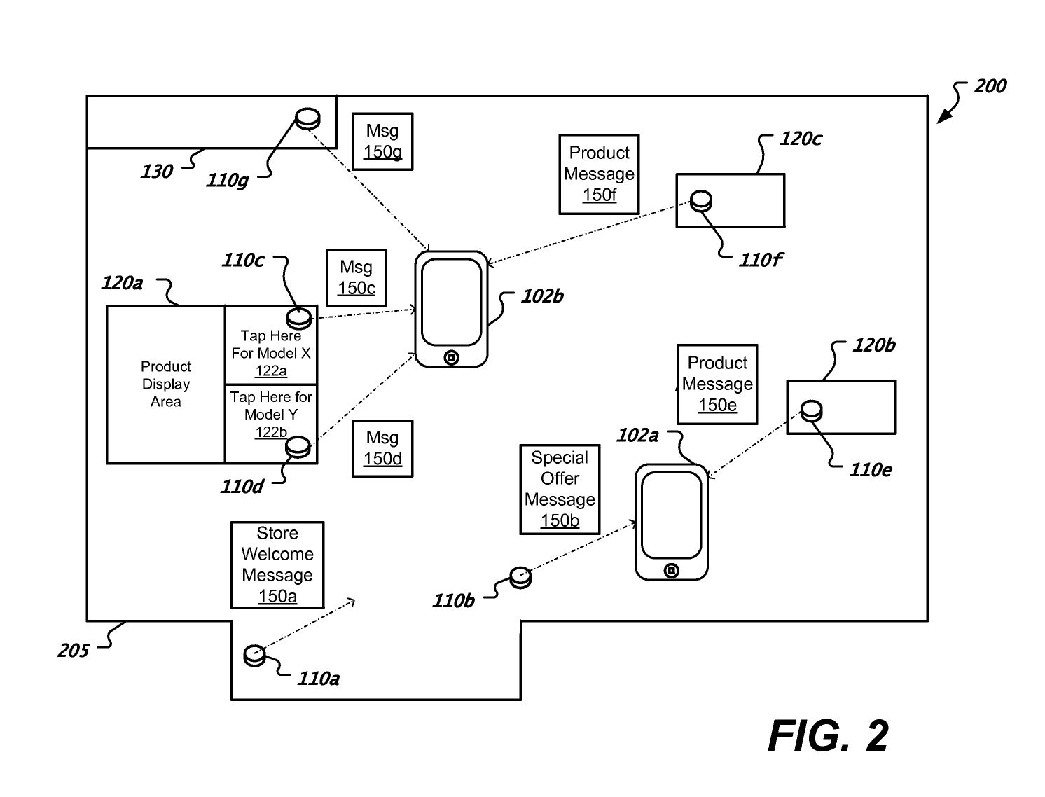

FIG. 2 is a plan view of an example operating environment 200 of a beacon-equipped establishment. In this example, the beacon-equipped establishment is a retail store 205 that includes beacon devices 110a-g. The beacon devices 110a-g can broadcast beacon messages 150a-g to mobile devices 102a-b using short-range communication links. On the mobile devices 102a-b, a retail store application can present the beacon messages to users of the mobile devices 102a-b to provide the users with an interactive shopping experience. In some implementations, the retail store application interacts with an operating system of the mobile device to perform the various processes described herein, and such implementations an operating system is considered to be an application.

The beacon devices 110a-g can be configured (locally or remotely over a network) to transmit messages that correspond to campaign messages that provide information related to the retail store 205 or events occurring at the retail store 205. For example, beacon device 110a can transmit a message 150a that corresponds to a store welcome campaign message. Beacon device 110b can transmit a message 150b corresponding to a special offer campaign message. In some implementations, a beacon message includes a beacon identifier, message value, or both. The retail store application can map the beacon identifier, message value, or both to a campaign message and display the corresponding campaign message on a screen of the mobile device 102a-b. In some implementations, campaign information including campaign messages can be downloaded from a network-based server computer to the mobile device 102a-b when the user first enters the retail store 205.

In some implementations, the retail store 205 can include beacon-equipped product demonstration tables 120a-c. For example, a table 120a can include a product display area and product information placards 122a-b having beacon devices 110c-d configured to broadcast respective beacon messages 150c-d corresponding to the respective products identified by the placards 122a-b. In some implementations, such beacon messages 150c-d provide additional information about the respective products through respective campaign messages. In some implementations, such beacon messages 150c-d trigger a process for the user to order or customize the product using the retail store application. In some implementations, the beacon devices 110c-d can be fixed to or embedded inside of the information placards 122a-b. If a user taps or swipes a mobile device 102a-b on or near one of the beacon devices 110c-d, thereby selecting the product model associated with the corresponding placard 122a-b, the retail store application causes a display of a message associated with the user-selected one of the placards 122a-b, i.e., beacon devices 110c-d. The retail store 205 can include additional tables 120b-c each equipped with beacon devices 110e-f that are configured to broadcast beacon messages 150e-f associated with the respective products being displayed on the tables 120b-c. Further, the retail store 205 can include a customer care center 130 that is equipped with a beacon device 110g that is configured to broadcast a beacon message 150g associated with the center 130.

The beacon devices 110a-g and the mobile devices 102a-b can use a short-range radio technology such as Bluetooth™ or a near field communication (NFC) technology for broadcasting and/or receiving beacon messages. In some implementations, the beacon devices 110a-g can use a specific type of Bluetooth™ called Bluetooth™ low energy (BLE). A wireless communication range of the beacon devices 110a-g can be between 10 to 30 meters. Other ranges are possible. When a mobile device 102a-b is within a wireless communication range of a beacon device 110a-g, it can receive a corresponding beacon message.

Various examples of mobile devices 102a-b include smartphones, tablet computers, notebook computers, or wearable computers. In some implementations, the mobile devices 102a-b can include a wireless receiver or transceiver that can scan the environment 200 for beacon messages from other devices, such as beacon devices 110a-g, in the environment 200. For example, a mobile device 102a-b can include a BLE receiver that scans for beacon messages. The mobile devices 102a-b can communicate with servers using a base station of a wireless network such as one based on Long Term Evolution (LTE) or Code Division Multiple Access (CDMA), e.g., CDMA2000 and Wideband CDMA (WCDMA). Other types of wireless networks are possible. In some implementations, a mobile device 102a-b can be configured to be a beacon device.

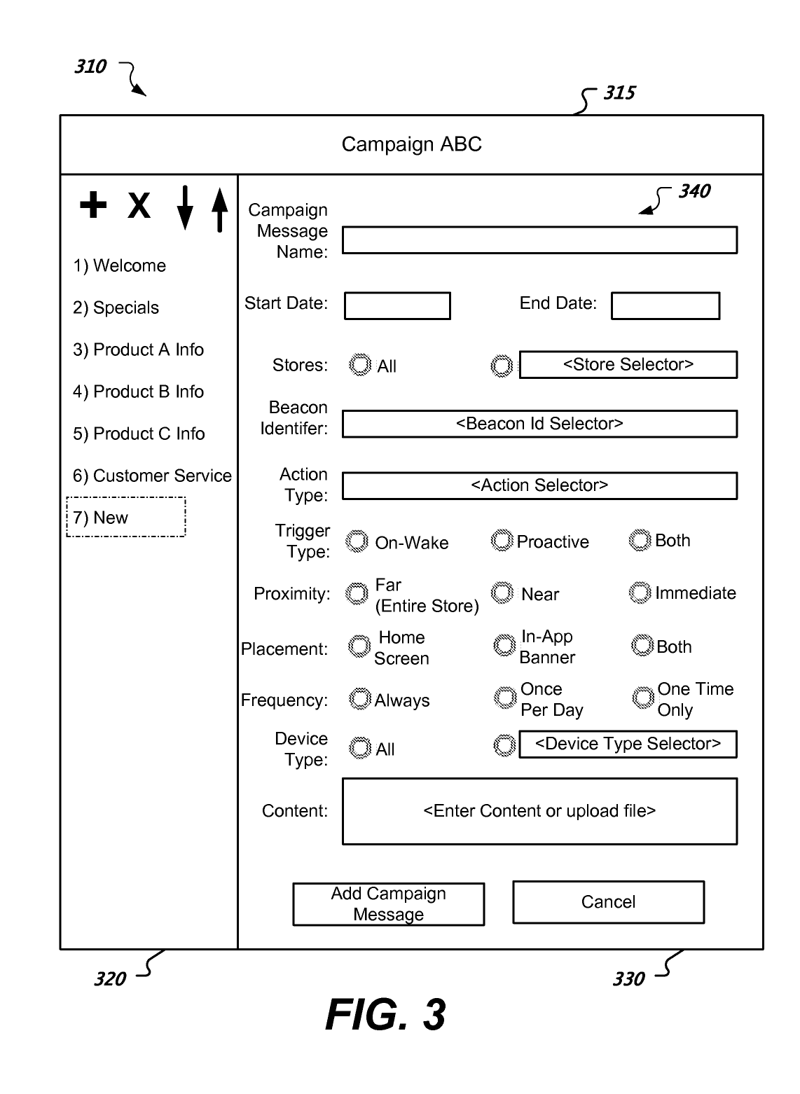

FIG. 3 illustrates a layout of an example graphical user interface 310 for a campaign creation and management engine. Hardware such as a server can be configured to run a campaign creation and management engine. Further, the server can provide one or more interfaces such as the graphical user interface 310 as a front-end interface to the campaign creation and management engine that is client accessible locally, remotely over a network, or both. In some implementations, the server can render the graphical user interface 310. In some implementations, an accessing client machine can render the graphical user interface 310 based on interface data received from the server. The interface 310 can include a campaign identifier pane 315, campaign message priority pane 320, and campaign message creation pane 330. Campaign identifier pane 315 can display a campaign name. The campaign message priority pane 320 can be used to display campaign messages associated with the campaign name, which can be displayed in order of relative priorities (e.g., higher priority messages are displayed above lower priority messages). The priority pane 320 can include user interface mechanisms for changing the priorities of campaign messages (e.g., an up-arrow virtual button for increasing relative priority and a down-arrow virtual button for decreasing relative priority). The priority pane 320 can include user interface mechanisms for creating and deleting campaign messages (e.g., “+” for creation and “X” for deletion).

The campaign message creation pane 330 can be used to define parameters 340 for a campaign message. The parameters 340 can include a campaign message name, start date, end date, store list, beacon identifier, action type, trigger type, proximity, device type, and content. Other and different types of parameters 340 are also possible from those depicted by FIG. 3.

The campaign message name parameter can specify a name of a campaign message. The start date and end date parameters can specify a starting date for the campaign message and an ending date for the campaign message, respectively. The store parameter can be used to associate a store with the campaign message. The beacon identifier parameter can specify a beacon identifier for the campaign message. After a mobile device receives a beacon message containing a beacon identifier, the mobile device can display content based on a campaign message corresponding to the received beacon identifier. In some implementations, the beacon identifier parameter can be selected from a drop-down menu that is populated with beacon identifiers that correspond to beacon devices known to be within a vicinity of the store. In some implementations, the server provides a store configuration interface to enter one or more beacon identifiers for a store.

The action type parameter can specify an action for a mobile device to perform in response to receiving a beacon message that contains a beacon identifier corresponding to the beacon identifier parameter of the campaign message. An action type, for example, can be to display a message based on the message content parameter. The content parameter can include a text string, image, audio, video, URL, or a combination thereof.

The trigger type parameter can specify a trigger for the campaign message. A mobile device can scan for beacon messages while in a low-power or sleep state (e.g., display is off). Should the mobile device receive a beacon message that corresponds to this campaign message while in the low-power or sleep state, the trigger type parameter can be used to determine at least in part whether to display the campaign message. Trigger types, for example, can include a “proactive” trigger and an “on-wake” trigger. The “proactive” trigger can cause the mobile device to immediately transition to an awake state to present the campaign message. The “on-wake” trigger can cause the mobile device to present the campaign message after the device transitions to the awake state via some other way, e.g., a user wakes the device by touching a button or screen. In some implementations, proactive triggers can be associated with a higher priority level than on-wake triggers.

The proximity parameter can specify a range threshold for controlling a presentation of the campaign message based on proximity. In some implementations, the proximity parameter can include a range class value (e.g., Far, Near, or Immediate) that is associated with a range of distances between the receiving mobile device and the transmitting beacon device. For example, if a campaign message requires that a mobile device has to be in the Immediate range class (e.g., less than 1-2 meters), the mobile device can display the campaign message if it determines that it is in the Immediate range class with respect to the beacon device. In some implementations, a proximity parameter having an Immediate range class can be associated with a higher priority level than other, more distant range classes such as Far or Near range classes.

The message placement parameter can specify a placement for the campaign message such as on a home screen of a mobile device, on an in-application banner, or both. The frequency parameter can specify a presentation frequency of a campaign message. For example, if the frequency parameter is set to “always,” a mobile device can present the campaign message for each encounter with a corresponding beacon device. If the frequency parameter is set to “once-per-day,” a mobile device can present the campaign message for the initial encounter of the day with a corresponding beacon device. If the frequency parameter is set to “one-time-only,” a mobile device can present the campaign message for the initial encounter with a corresponding beacon device, and thereafter is not presented again. In some implementations, a campaign message refresh may reset the history, e.g., one-time-only per refresh cycle.

A target device type parameter can specify a type of device for the campaign message. A campaign message, for example, can be created to inform customers about a promotion to upgrade to a new mobile device model. In some implementations, the target device type parameter can be set to exclude new mobile device models from presenting device upgrade campaign messages. In some implementations, the target device type parameter can include an identifier list of one or more device type identifiers. A mobile device matching a device type identifier in the identifier list can present the device upgrade campaign message. In some implementations, the target device type parameter can be selected from a drop-down menu that is populated with device types. Other campaign parameters can include campaign start and end dates, expected proximity from beacon for campaign to be displayed (e.g., Far, Near, Immediate, etc.), campaign display frequency (e.g., always, one time per visit, one time only, etc.), and campaign priority to enforce the desired behavior when in the range of eligible campaigns.

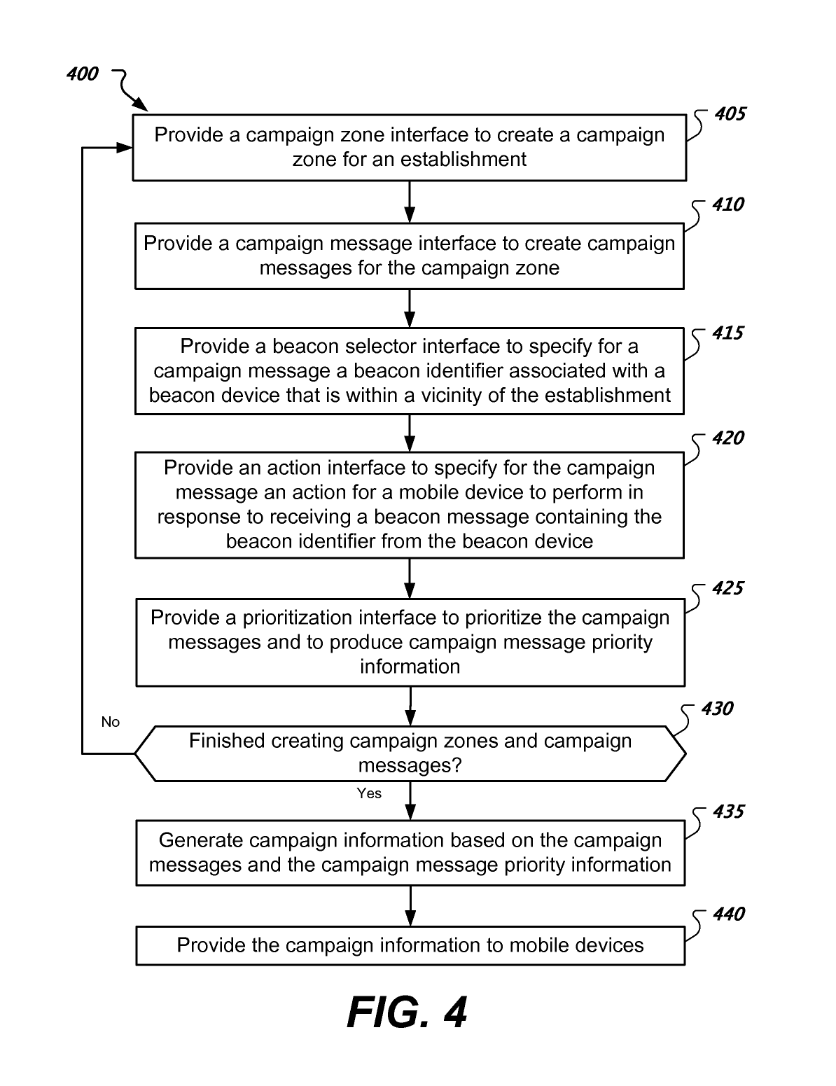

FIG. 4 illustrates an example process 400 performed by a campaign management system. The process 400 can provide a campaign zone interface to create a campaign zone for an establishment (405). In some implementations, providing interfaces such as the campaign zone interface can include exchanging data with a remote client over a network, where the remote client is responsible for graphical rendering via a web browser, standalone application, or both. In some implementations, the campaign zone interface can include a data entry mechanism for entering a name of a campaign zone. In some implementations, providing interfaces can include sending or receiving data via a protocol such as Transmission Control Protocol/Internet Protocol (TCP/IP) or User Datagram Protocol (UDP). In some implementations, providing interfaces can include sending or receiving data via a web based protocol such as Hypertext Transfer Protocol (HTTP) or Hypertext Transfer Protocol Secure (HTTPS).

The process 400 can provide a campaign message interface to create campaign messages for the campaign zone (410). In some implementations, the campaign message interface can include a data entry mechanism for campaign message parameters such as a beacon identifier parameter, action type parameter, trigger type parameter, proximity threshold parameter, message frequency parameter, message placement parameter, device type parameter, and message content parameter.

The process 400 can provide a beacon selector interface to specify for a campaign message a beacon identifier associated with a beacon device that is within a vicinity of the establishment (415). The specified beacon identifier can be stored in a beacon identifier parameter of a record for the campaign message. In some implementations, the campaign message interface includes the beacon selector interface.

The process 400 can provide an action interface to specify for the campaign message an action for a mobile device to perform in response to receiving a beacon message containing the beacon identifier from the beacon device (420). The specified action can be stored in an action type parameter of a record for the campaign message. In some implementations, the campaign message interface can include the action interface. In some implementations, an action can include displaying content from a message content parameter. In some implementations, an action can include operating a web browser to go to a web page specified by the message content parameter. In some implementations, actions can include opening a browser on a specific URL, redirecting the customer to a specific place in the current application and have this application execute a specific action, or open a different application on a specific deep-link (e.g., download an application from an application store, download a music track from an online store, open maps on a location, etc.).

The process 400 can provide a prioritization interface to prioritize the campaign messages and to produce campaign message priority information (425). In some implementations, the prioritization interface can include virtual buttons to increase or decrease a relative priority of a campaign message with respect to other messages in a campaign zone. In some implementations, the campaign message priority information is represented as a list of campaign message index values that are ordered based on their relative priorities.

The process 400 can determine whether campaign zone and campaign message creation is finished (430). In some implementations, the process 400 can provide a “finished” virtual button, that if selected signals that the campaign zone and campaign message creation is finished. If not finished, the process 400 continues to provide the interfaces for additional campaign zone and campaign message creation. If finished, the process 400 can generate campaign information based on the campaign messages and the campaign message priority information (435). In some implementations, generating campaign information can include creating a campaign file that includes campaign message records. In some implementations, the process 400 creates campaign message records based on information provided via one or more interfaces. In some implementations, the process 400 can order the campaign message records associated with a campaign zone based on their relative priorities. In some implementations, the process 400 can include one or more priority values in one or more respective campaign message records based on the campaign message priority information. In some implementations, a priority value can be determined based on a campaign message index. In some implementations, the campaign information provides one or more campaign rules to control how a mobile device presents one or more of the campaign messages in response to receiving one or more beacon messages that are associated with a campaign zone. In some implementations, the campaign information provides one or more rules to control a presentation order of two or more of the campaign messages in response to receiving multiple different beacon messages. In some implementations, a presentation order can specify the order in which the messages are displayed. In some implementations, a campaign rule can be encoded in one or more parameters of a campaign message record. In some implementations, a campaign rule can be encoded in campaign rule record.

The process 400 can provide the campaign information to mobile devices (440). In some implementations, providing the campaign information can include sending a file that contains campaign messages to an application running on a mobile device. In some implementations, providing the campaign information to mobile devices can include sending a campaign file to a distribution server that is configured to distribute the campaign file on-demand.

In some implementations, the process 400 can provide an interface to specify for the campaign message one or more primary level criteria for determining whether to present a campaign message parameter. In some implementations, campaign message priority information can include one or more secondary level criteria to resolve a tie if two or more campaign messages within a zone qualify for presentation based on respective one or more primary level criteria. In some implementations, primary level criteria can include parameters such as a proximity based parameter, trigger based parameter, or a target device type parameter. In some implementations, secondary level criteria an include campaign priority values. For example, if two or more campaign messages qualify for presentation at a mobile device, then the one having a higher campaign priority value can win the tie.

In some implementations, the process 400 can receive campaign zone information from a mobile device. Various examples of campaign zone information include a campaign identifier, a detected beacon identifier that is detected by the mobile device, or location information such as GPS coordinates that are based on a geographical location of the mobile device. Other types of campaign zone information are possible. The process 400 can identify a campaign zone that corresponds to the campaign zone information. In some implementations, identifying a campaign zone can include querying a campaign database with a detected beacon identifier to locate a campaign zone that contains a campaign message matching the detected beacon identifier. In some implementations, identifying a campaign zone can include querying a campaign database with received location information to locate a campaign zone that is associated with the received location information. The process 400 can include retrieving campaign information corresponding to the identified campaign zone. The process 400 can include sending the retrieved campaign information to the mobile device. The retrieved campaign information can include a retrieved campaign file.

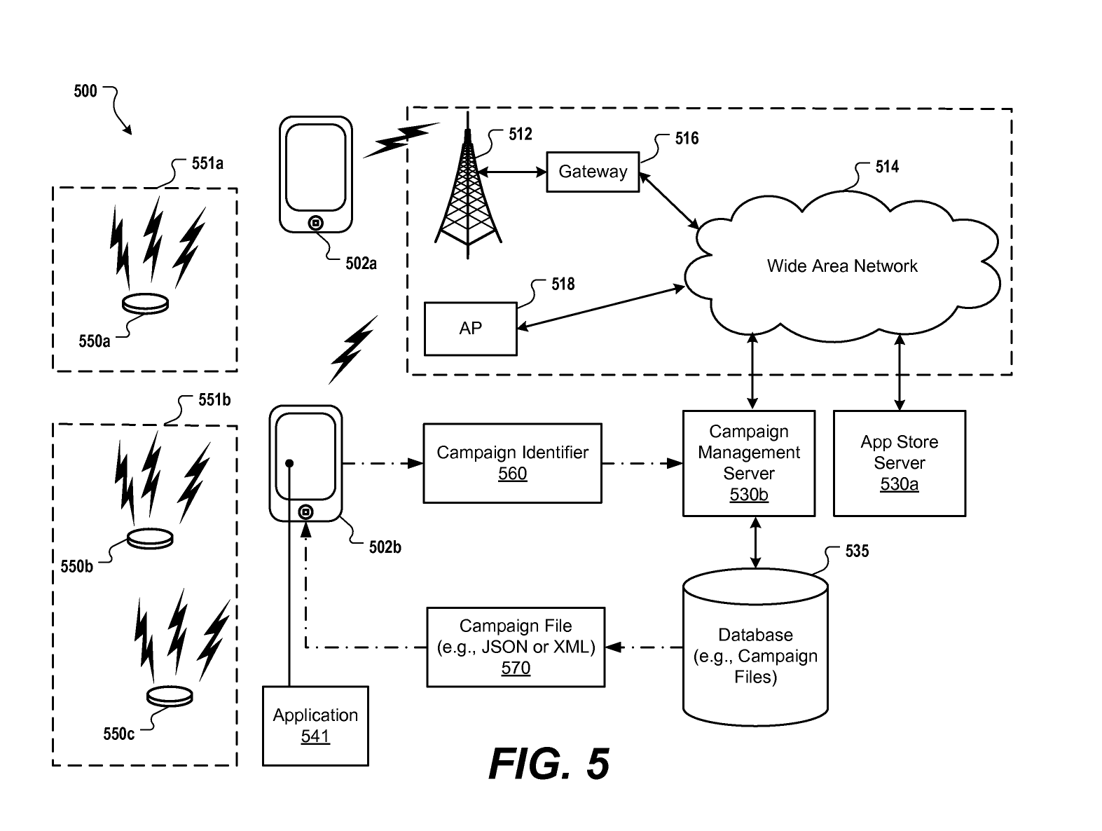

FIG. 5 illustrates an example operating environment for beacon-based campaigns. Mobile devices 502a-b, for example, can communicate over one or more wireless networks. For example, a base station 512 of a wireless network, e.g., a cellular network, can communicate with a wide area network (WAN) 514, such as the Internet, by use of a gateway 516. Likewise, an access point (AP) 518, such as an IEEE 802.11 family based wireless access point, can provide communication access to the wide area network 514. The mobile device 502a-b can, for example, communicate with one or more servers 530a-b via the base station 512, access point 518, or combination thereof. The servers 530a-b can include a network interface configured to communicate with devices such as the mobile devices 502a-b. The servers 530a-b can include one or more processors configured to communicate with devices such as the mobile devices 502a-b via the network interface using a protocol such as TCP/IP or UDP. The servers 530a-b can include one or more memory structures such as random access memory (RAM), hard disk drive (HDD), or solid state drive (SSD). Other types of memory structures are possible.

Mobile devices 502a-b can include an application 541 to process one or more beacon messages received over a short-range communication link from one or more beacon devices 550a-c. In some implementations, the short-range communication link can be based on Bluetooth radio technology. In some implementations, the short-range communication link can be based on NFC radio technology. In some implementations, the mobile devices 502a-b can be configured to continuously scan for beacon messages. In some implementations, the mobile devices 502a-b can be configured to scan for beacon messages for a predetermined time period based on the application 541 invoking a beacon scan routine.

The beacon devices 550a-c can be associated with campaign zones 551a-b. In some implementations, the campaign zones 551a-b correspond to different establishments, e.g., different store locations. A mobile device 502b can determine a campaign identifier 560 that corresponds with a campaign zone 551b based on a proximity to an associated establishment. In some implementations, the campaign identifier 560 is determined based on using location technology such as GPS or a network-based location service, comparing the resulting location data with geographical boundaries associated with the campaign zones 551a-b, and selecting a campaign identifier of the nearest campaign zone. In some implementations, the campaign identifier 560 is determined based on information from a received beacon message. The mobile device 502b can send a campaign identifier 560 in a request message to the campaign management server 530b.

In response, the campaign management server 530b can retrieve campaign information corresponding to the campaign identifier 560 from a database 535. The campaign management server 530b can send the retrieved campaign information as a campaign file 570 to the mobile device 502b. Using the campaign file 570, the mobile device 502b can identify campaign messages that correspond to the received beacon messages. Zero, one, or more of the identified campaign messages can be presented in accordance with one or more rules and priority information included in the campaign file 570. In some implementations, a campaign identifier 560 provided to the campaign management server 530b can be any of the beacon identifiers associated with the campaign zones 551a-b; and the campaign management server 530b can respond with a campaign file 570 that contains one or more campaign messages with at least one of the messages corresponding to the campaign identifier 560.

In some implementations, based on receiving a beacon message over a short-range communication link from a beacon device 550a-c, the mobile devices 502a-b can establish communications with one or more servers 530a-b via a long-range communication link associated with a base station 512 that provides cellular data services. For example, a beacon message from a beacon device 550a-c can cause the mobile devices 502a-b to retrieve the application 541 from an application store server 530a. In some implementations, the mobile devices 502a-b have already retrieved and are running the application 541 before receiving the beacon message from the beacon device 550a-c. The application 541 can be configured to download campaign information such as the campaign file 570 from the campaign management server 530b. In some implementations, the application 541 can download campaign information from the campaign management server 530b in response to an initial reception of a beacon message such as a welcome message. In some implementations, campaign information can include one or more priority rule sets, campaign parameters, and campaign message content.

The campaign management server 530b can store campaign information for different campaign zones 551a-b in a database 535. In some implementations, the campaign information includes mappings between beacon message values (e.g., identifier, major, and/or minor values) and corresponding message data (e.g., text, picture, video, and/or audio). After downloading campaign information from the campaign management server 530b, the mobile devices 502a-b can use the mappings and message texts to translate a received beacon message into a format that is suitable for display to users of the mobile devices 502a-b.

In some implementations, each campaign zones 551a-b has a corresponding campaign file, e.g., campaign file 570. In some implementations, a campaign file 570 can include one or more records containing attribute-value pairs, e.g., pairs for a beacon identifier, major value, minor value, and an action-response such as a text string or image for displaying to a user. In some implementations, a campaign file 570 can be based on a file type such as Extensible Markup Language (XML) or JavaScript Object Notation (JSON). Other file types are possible.

A JSON based campaign file, for example, can include the following text:

```
{
  “beaconUUID”: “A2F56DB5-EFFB-58D2-C060-C0F5F81096E5”,
  “beaconIdentifier”: “com.store_no_3953”,
  “beacons”: [{
    “major”: 1,
    “minor”: 66,
    “action”: “message”,
    “url”: “”,
    “message”: {
    “en”: “Welcome to the Store!”}
  }, {
    “major”: 3,
    “minor”: 2,
    “action”: “url”,
    “url”: “https://retailstore.com/us/modelx-info”,
    “message”: {
    “en”: “Interested in the Model X? Click on link for more
information”}
  }]
}
```

This example JSON file snippet includes different actions associated with different major and minor values for a beacon universally unique identifier (UUID) and beacon identifier pair. A beacon message, for example, can include one or more identifiers such as a UUID, beacon identifier and a message value. A message value can be separated into a major value and a minor value. Based on receiving this beacon message, the mobile device 502a-b can locate a matching record within the JSON file (e.g., matching message values and identifier values) and perform the action specified by the matching record.

Beacon devices 550a-c can include circuitry such as a processor, memory, and a transmitter for broadcasting beacon messages. In some implementations, the beacon devices 550a-c can include a physical interface for programming the beacon devices 550a-c, which can be a USB interface or a two-way wireless interface such as an LTE or IEEE 802.11 based network interface.

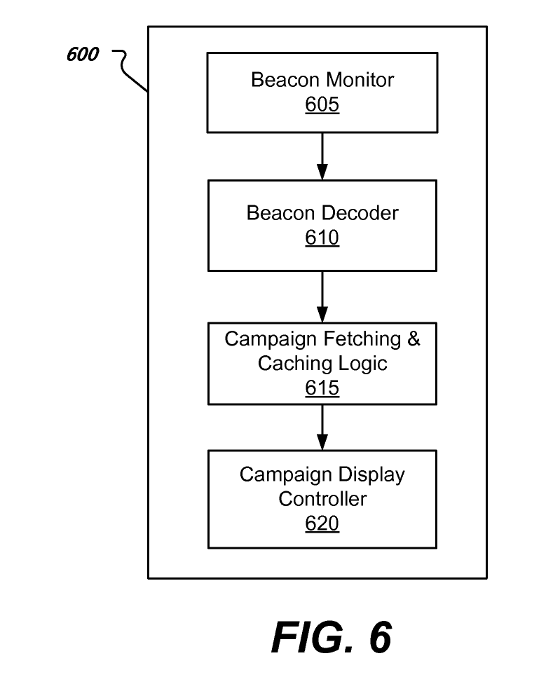

FIG. 6 illustrates a high level architecture of an example mobile device 600. The mobile device 600 can include a beacon monitor 605, beacon decoder 610, campaign fetching and caching logic 615, and campaign display controller 620. The beacon monitor 605 can be configured to provide payloads of received beacon messages within range of the mobile device 600. The beacon decoder 610 can be configured to extract information from a beacon payload such as a beacon identifier, message values, or both. The campaign fetching and caching logic 615 can retrieve from a campaign related server one or more campaign zones within range of the mobile device 600. In some implementations, the campaign fetching and caching logic 615 sends a received beacon identifier to a campaign related server to retrieve associated campaign information. In some implementations, the campaign fetching and caching logic 615 retrieves information from a server based on scheme-specific rules such as a configurable refresh rate, session times, device states, etc. The campaign display controller 620 can use the retrieved campaign information and one or more received beacon messages to present campaign messages via the mobile device 600. In some implementations, the campaign display controller 620 can present messages based on campaign message parameters, beacon device(s) in range and proximity, and scheme-specific rules.

In some implementations, the campaign fetching and caching logic 615 determines whether to present a message based on proximity. In some implementations, proximity to a beacon device can be used as criteria to determine priorities for received beacon message in accordance with campaign information. For example, a mobile device can receive messages from different beacon devices having different proximities with the mobile device. Using information such as an RSSI value corresponding to a received beacon message, the mobile device can determine proximity information such as a range class for the received beacon message that can be used by an application that needs to know at least an approximate distance between a mobile device and an RF signal source, such as a beacon device. In some implementations, RSSI values associated with received beacon messages can be assigned to range classes based on RSSI thresholds without converting the RSSI values to distances. In some implementations, range classes include: Immediate, Near, Far, and Unknown. More or fewer range classes can be used as needed for an application. For example, the Immediate range class can be defined as a range between a mobile device and a RF signal source that is, e.g., 0 to 30 centimeters. The Near range class can be defined as a range between a mobile device and a RF signal source that is, e.g., 30 centimeters to 4 meters. The Far range class can be defined as a range between a mobile device and a RF signal source that is, e.g., 4 to 30 meters. The Unknown range class can be defined as the range between a mobile device and a signal source (e.g., greater than 30 meters). Distance thresholds can separate the range classes. The distance thresholds (e.g., in meters) can be converted to RSSI thresholds in dBm to enable classification of RSSI values, where the range classes are separated by RSSI thresholds.

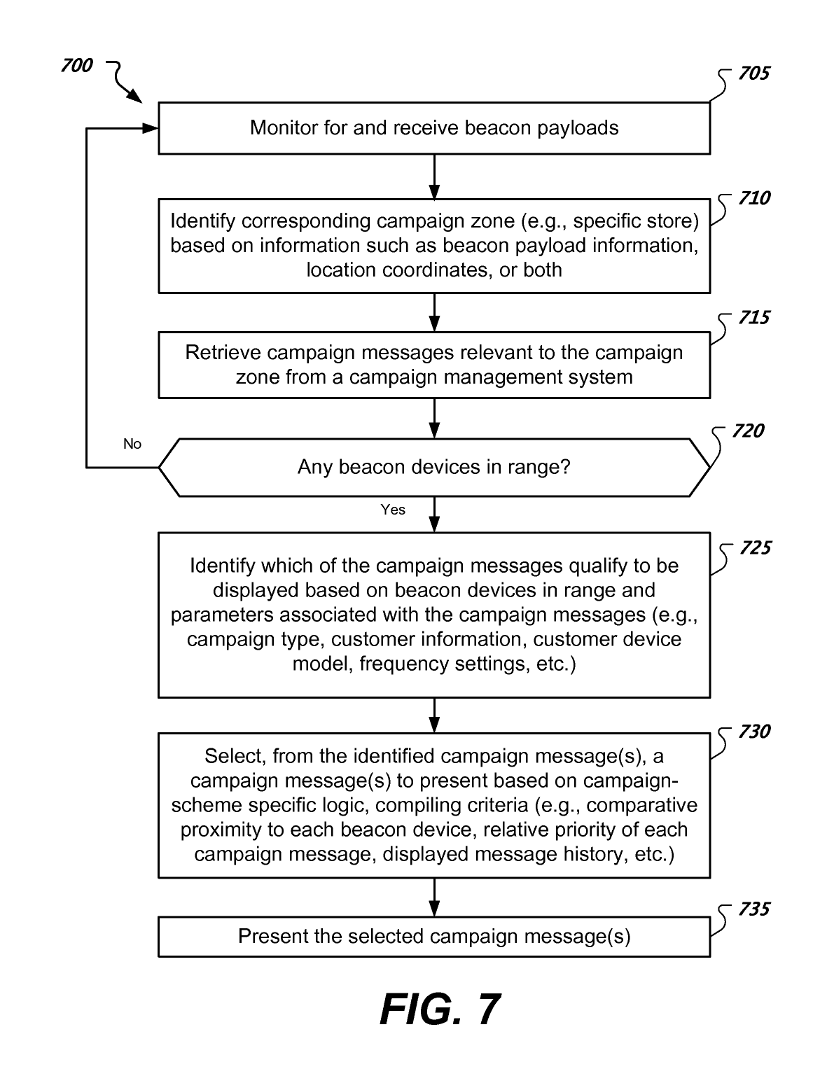

FIG. 7 illustrates an example process 700 performed by a mobile device to process beacon messages and associated campaigns. The process 700 can monitor for and receive beacon payloads (705). The process 700 can identify a corresponding campaign zone (e.g., specific store) based on information such as beacon payload information (e.g., beacon identifier), location coordinates, or both (710). In some implementations, the location coordinates are obtained via a GPS or a network-based location service. The process 700 can retrieve campaign messages relevant to the campaign zone from a campaign management system (715).

The process 700 can determine whether any beacon devices are in range (720). If there are no beacon devices in range, the process 700 can continue to monitor for and receive beacon payloads. If there are one or more beacon devices in range, then the process 700 can identify which of the campaign messages qualify to be displayed based on beacon devices in range and parameters associated with the campaign messages (725). The associated parameters can include campaign type (e.g., service notification, marketing, etc.), customer information, customer device model, or frequency settings. Other types of parameters are possible. The process 700 can select, from the identified campaign message(s), a campaign message(s) to present based on campaign-scheme specific logic, compiling criteria (730). In some implementations, the criteria can include comparative proximity to each beacon device, relative priority of each campaign message, displayed message history, or other criteria. The process 700 can present the selected campaign message(s) (735).

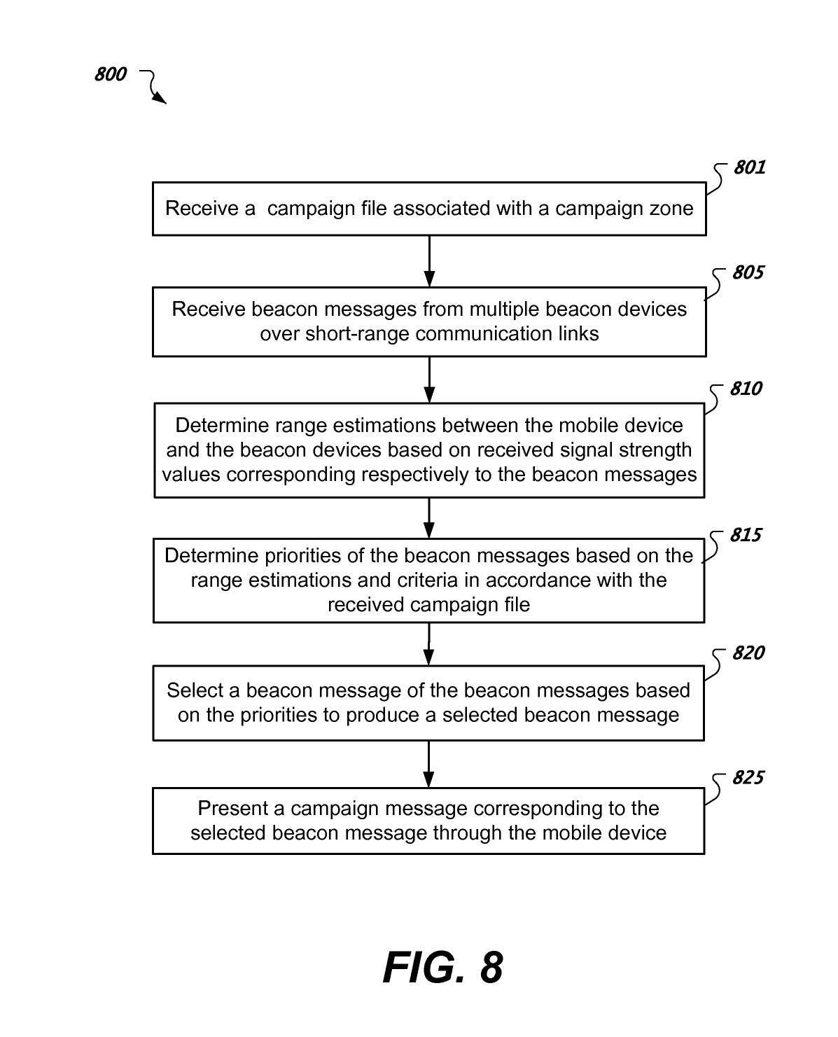

FIG. 8 illustrates another example process 800 performed by a mobile device to process beacon messages and associated campaigns. The process 800 can receive a campaign file associated with a campaign zone (801). In some implementations, the process 800 can retrieve the campaign file from a network source based on a received beacon message. The process 800 can receive beacon messages from multiple beacon devices over short-range communication links (805). In some implementations, the process 800 can include activating a scan for beacon messages from beacon devices that are in the vicinity of the mobile device. As used herein, “in the vicinity” means the mobile device is physically close enough to the beacon device to receive RF signals transmitted by the beacon device. For example, a wireless transceiver on the mobile device can initiate a short-range scan for RF signals such as BLE RF signals or NFC RF signals.

The process 800 can estimate the range between the mobile device and each beacon device in communication with the mobile device based on received signal strength values corresponding respectively to the beacon messages (810). In some implementations, process 800 collects RF signal measurements associated with the beacon messages and computes RSSI values for each of the beacon messages. In some implementations, an RSSI can be mathematically defined as being approximately a ratio of the power of a received signal and a reference received power (e.g., 1 mW), where the higher the RSSI number (or less negative) the stronger the signal. In some implementations, a RSSI value can be expressed in dBm. Based on a predetermined transmission power for transmitting beacon messages, range estimation can be computed based on the RSSI value. Determining range estimations can include using channel quality information such as a bit error rate (BER) or a packet error rate (PER) derived from a received beacon message.

The process 800 can determine priorities of beacon messages based on the range estimations and criteria in accordance with the received campaign file (815). Various examples of criteria include but are not limited to: proximity-based criteria, context-based criteria, device-based criteria, content-based criteria, and timing criteria. Other types of criteria are possible. In some implementations, determining priorities can include accessing campaign message records in the received campaign file and computing priorities based record parameters such as action type parameter, trigger type parameter, proximity threshold parameter, message frequency parameter, message placement parameter, device type parameter, and message content parameter. In some implementations, priorities can be stored as numerical values, where higher values correspond to higher priorities. In some implementations, determining priorities can include assigning beacon messages to priority classes such as high priority, intermediate priority, and low priority. More or fewer priority classes can be used as needed for an application. In some implementations, a priority class can include two or more subclasses to provide additional priority granularity. In some implementations, determine priorities of the beacon messages can include ordering beacon messages in a queue such that the highest priority message is at the top of the queue. In some implementations, beacon messages that are determined to have a priority not exceeding a minimum priority threshold can be deleted. In some implementations, beacon messages that do not qualify for presentation can be deleted (e.g., the mobile device is not permitted to display the message because it is not listed in a campaign message's target device type parameter).

In some implementations, determining the priorities (815) can include using the range estimations such that a message from a beacon device that is closer to the mobile device has a higher priority than a message from a beacon device that is farther away from the mobile device. In some implementations, determining the priorities can include applying one or more rule sets to the beacon messages to compute priority values. In some implementations, a rule set can be selected based on a reason for a visit to the retail store, such as to pick up an earlier placed order or to have a consultation with a store employee.

The process 800 can select a beacon message of the beacon messages based on the priorities to produce a selected beacon message (820). Selecting a beacon message can include determining the highest priority of the priorities and selecting a beacon message of the beacon messages that corresponds to the highest priority. In some implementations, selecting a beacon message can include selecting a message at the top of a message queue that is organized by message priority. In some implementations, the process 800 can select multiple beacon messages for display and place them in order of priority in a display stack data structure, where the top of the display stack is the highest priority message and is displayed first.

The process 800 can present a campaign message corresponding to the selected beacon message through the mobile device (825). Presenting the corresponding campaign message can include displaying information from a message content parameter of the campaign message on a screen of the mobile device. In some implementations, the process 800 can select multiple beacon messages for display and create a prioritized display order. In some implementations, displaying information can include displaying a first one of multiple beacon messages based on the prioritized display order, and later displaying a second one of multiple beacon messages that has a lower priority than the previously displayed message. In some implementations, the second one is displayed after the first one has been dismissed or acknowledged. In some implementations, the process 800 can provide one or more notifications associated with the selected beacon message. An indication can include a force feedback (e.g., vibration indication), audio indication (e.g., beep, music, etc.), visual indication (e.g., flashing light), or a combination thereof. In some implementations, message content parameter can include any content including but not limited to: text, graphics, digital images, audio, video, and animation. Campaign messages can be presented on the mobile device in the form of audio output to work with mobile devices without display capability or to assist visually impaired users.

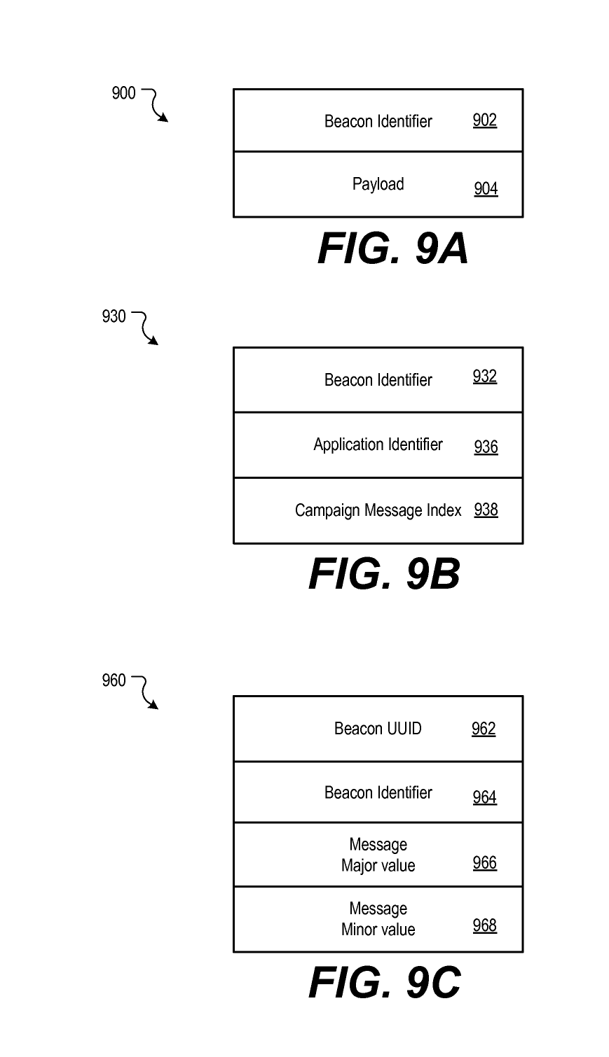

FIGS. 9A, 9B, and 9C illustrate different examples of beacon message formats. In FIG. 9A, the format 900 includes a beacon identifier 902 and a payload 904. In some implementations, the beacon identifier 902 can include a text string such as “com.company.store_no_9954.” In some implementations, the beacon identifier 902 can include a hexadecimal value such as “0x0e99de54.” Other types of identifiers are possible. The payload 904 can include a message value that corresponds to a campaign message. In some implementations, the payload 904 includes the beacon identifier 902. In some implementations, the beacon identifier 902 is associated with and can be used to identify a campaign zone. In some implementations, a message index value within the payload 904 can be used to select a campaign message within a campaign file associated with the campaign zone. In some implementations, the beacon identifier 902 is used to select a campaign message within a campaign file associated with the campaign zone.

In FIG. 9B, the format 930 includes a beacon identifier 932, application identifier 936, and a campaign message index 938. The application identifier 936 can identify an application running on the mobile device for handling the beacon message upon reception at a mobile device. For example, an operating system running on the mobile device can use the application identifier 936 to forward the beacon message to an application corresponding to the application identifier 936. In some implementations, if the application is not already installed on the mobile device, a browser can be launched on the mobile device and direct the user (e.g., using a URL) to a website where the user can download and install the application corresponding to the application identifier 936. In some implementations, the application can be downloaded automatically without user intervention in a manner that is transparent to the user (e.g., as a background process). In some implementations, if the application is installed but not running on the mobile device, the application can be launched automatically by the operating system running on the mobile device to receive the beacon message.

In FIG. 9C, the format 960 includes a UUID 962, beacon identifier 964, message major value 966, and message minor value 968. An establishment can include multiple beacon devices having the same beacon identifier 964. However, such beacons can have different values for the beacon UUID 962. Thus, the beacon UUID 962 can serve to differentiate among beacon devices sharing the same beacon identifier 964. In some implementations, the beacon identifier 964 includes the beacon UUID 962. In some implementations, the UUID 962 is a 128-bit value. In some implementations, a message value split between the message major value 966 and the message minor value 968 can serve to differentiate among beacon devices sharing the same beacon identifier 964. In some implementations, the major value 966 and the minor value 968 are different 16-bit portions of a 32-bit value. In some implementations, the minor value 968 specifies a subtype from a group associated with the major value 966. For example, the major value 966 can specify a value associated with displaying user messages, and the minor value 968 can specify which user message to display.

In some implementations, an application running on a mobile device can process the major value 966 and the minor value 968 based on a received campaign file that associates major and minor values with specific actions. In some implementations, the internal database includes information from a JSON based file or data stream containing attribute-value pairs, e.g., one or more records containing a beacon identifier, major value, minor value, and an action-response such as a text string for displaying to a user. In some implementations, a JSON based file can include different actions associated with different major and minor values for a beacon UUID and identifier pair. Based on receiving a major and minor value from the beacon device associated with the beacon UUID and identifier pair, a mobile device would perform the action associated with the corresponding major value entry and minor value entry within the JSON file.

FIG. 11 is a block diagram of example mobile device architecture. The architecture may be implemented in any device 1000 for generating the features described in this specification, including but not limited to portable computers, smart phones and electronic tablets, game consoles, wearable devices and the like. Device 1000 may include memory interface 1002, data processor(s), image processor(s) or central processor(s) 1004, and peripherals interface 1006. Memory interface 1002, processor(s) 1004 or peripherals interface 1006 may be separate components or may be integrated in one or more integrated circuits. One or more communication buses or signal lines may couple the various components.

Sensors, devices, and subsystems may be coupled to peripherals interface 1006 to facilitate multiple functionalities. For example, motion sensor 1010, light sensor 1012, and proximity sensor 1014 may be coupled to peripherals interface 1006 to facilitate orientation, lighting, and proximity functions of the device. For example, in some implementations, light sensor 1012 may be utilized to facilitate adjusting the brightness of touch surface 1046. In some implementations, motion sensor 1010 (e.g., an accelerometer, gyros) may be utilized to detect movement and orientation of the device. Accordingly, display objects or media may be presented according to a detected orientation (e.g., portrait or landscape). Other sensors may also be connected to peripherals interface 1006, such as a temperature sensor, a biometric sensor, or other sensing device, to facilitate related functionalities. Location processor 1015 (e.g., GPS receiver chip) may be connected to peripherals interface 1006 to provide geo-positioning. Electronic magnetometer 1016 (e.g., an integrated circuit chip) may also be connected to peripherals interface 1006 to provide data that may be used to determine the direction of magnetic North. Thus, electronic magnetometer 1016 may be used as an electronic compass. Camera subsystem 1020 and an optical sensor 1022, e.g., a charged coupled device (CCD) or a complementary metal-oxide semiconductor (CMOS) optical sensor, may be utilized to facilitate camera functions, such as recording photographs and video clips. Audio subsystem 1026 may be coupled to a speaker 1028 and one or more microphones 1030 to facilitate voice-enabled functions, such as voice recognition, voice replication, digital recording, and telephony functions.

Communication functions may be facilitated through one or more communication subsystems 1024. Communication subsystems 1024 may include one or more wireless communication subsystems. Wireless communication subsystems 1024 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystems 1024 may depend on the communication network(s) or medium(s) over which the device 1000 is intended to operate. For example, a device may include wireless communication subsystems designed to operate over LTE, GSM, a GPRS network, an enhanced data GSM environment (EDGE) network, 802.x communication networks (e.g., Wi-Fi, Wi-Max), CDMA networks, NFC and a Bluetooth™ network. Communication subsystems 1024 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

I/O subsystem 1040 may include touch controller 1042 and/or other input controller(s) 1044. Touch controller 1042 may be coupled to a touch surface 1046. Touch surface 1046 and touch controller 1042 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 1046. In one implementation, touch surface 1046 may display virtual or soft buttons and a virtual keyboard, which may be used as an input/output device by the user.

Other input controller(s) 1044 may be coupled to other input/control devices 1048, such as one or more buttons, rocker switches, thumb-wheel, infrared port, USB port, and/or a pointer device such as a stylus. The one or more buttons (not shown) may include an up/down button for volume control of speaker 1028 and/or microphone 1030. In some implementations, device 1000 may present recorded audio and/or video files, such as MP3, AAC, and MPEG video files. In some implementations, device 1000 may include the functionality of an MP3 player and may include a pin connector for tethering to other devices. Other input/output and control devices may be used.

Memory interface 1002 may be coupled to memory 1050. Memory 1050 may include high-speed random access memory or non-volatile memory, such as one or more magnetic disk storage devices, one or more optical storage devices, or flash memory (e.g., NAND, NOR). Memory 1050 may store operating system 1052, such as Darwin, RTXC, LINUX, UNIX, OS X, WINDOWS, or an embedded operating system such as VxWorks. Operating system 1052 may include instructions for handling basic system services and for performing hardware dependent tasks. In some implementations, operating system 1052 may include a kernel (e.g., UNIX kernel).

Memory 1050 may also store communication instructions 1054 to facilitate communicating with one or more additional devices. Communication instructions 1054 may also be used to select an operational mode or communication medium for use by the device, based on a geographic location (obtained by the GPS/Navigation instructions 1068) of the device. Memory 1050 may include graphical user interface instructions 1056 to facilitate graphic user interface processing, including a touch model for interpreting touch inputs and gestures; sensor processing instructions 1058 to facilitate sensor-related processing and functions; phone instructions 1060 to facilitate phone-related processes and functions; electronic messaging instructions 1062 to facilitate electronic-messaging related processes and functions; web browsing instructions 1064 to facilitate web browsing-related processes and functions; media processing instructions 1066 to facilitate media processing-related processes and functions; GPS/Navigation instructions 1068 to facilitate GPS and navigation-related processes; camera instructions 1070 to facilitate camera-related processes and functions; and application storage 1072 for storing applications, such as a retail store application that is configured to receive and prioritize beacon messages. In some implementations, such applications can be pre-installed on the device 1000, downloaded from an application store server, or a combination thereof. The retail store application can include a rules-based engine that processes beacon messages according to rule sets, as described herein.

Each of the above identified instructions and applications may correspond to a set of instructions for performing one or more functions described above. These instructions need not be implemented as separate software programs, procedures, or modules. Memory 1050 may include additional instructions or fewer instructions. Furthermore, various functions of the device may be implemented in hardware and/or in software, including in one or more signal processing circuits, FPGA (field programmable gate array), or an ASIC (application-specific integrated circuit).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., C, C++, Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, one or more ASICs or FPGAs.

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The apparatus can also include one or more memory structures such as nonvolatile memory, volatile memory, or both.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
providing, by a data processing apparatus, a graphical user interface to create a campaign zone for a location, create campaign messages for the campaign zone, prioritize the campaign messages, and produce campaign message priority information, wherein the graphical user interface is configured to specify for a campaign message a beacon identifier associated with a beacon device that is within a vicinity of the location, and to specify for the campaign message an action for a mobile device to perform in response to receiving a beacon message containing the beacon identifier from the beacon device;
generating, by the data processing apparatus, campaign information based on the campaign messages and the campaign message priority information; and
providing, by the data processing apparatus, the campaign information to mobile devices.

2. The method of claim 1, wherein providing the campaign information to the mobile devices comprises sending the campaign information to an application running on the mobile device, wherein the campaign information controls how the application presents one or more of the campaign messages in response to receiving one or more beacon messages that are associated with the campaign zone.

3. The method of claim 1, wherein the campaign information controls a presentation order of two or more of the campaign messages in response to receiving multiple different beacon messages that are associated with the campaign zone.

4. The method of claim 1, wherein the graphical user interface comprises an interface to specify for the campaign message one or more first level criteria for determining whether to present a campaign message parameter, and wherein the campaign message priority information comprises one or more second level criteria to resolve a tie if two or more of the campaign messages qualify for presentation based on respective one or more first level criteria.

5. The method of claim 1, wherein the campaign information comprises one or more campaign message records, and wherein the one or more campaign message records comprise a beacon identifier parameter corresponding to the beacon identifier, an action type parameter corresponding to the action, a proximity threshold parameter, message frequency parameter, and message content parameter.

6. The method of claim 1, comprising:
receiving campaign zone information from the mobile device;
identifying a campaign zone that corresponds to the campaign zone information;
retrieving campaign information corresponding to the identified campaign zone; and
sending the retrieved campaign information to the mobile device.

7. The method of claim 6, wherein the campaign zone information comprises a detected beacon identifier that is detected by the mobile device.

8. The method of claim 6, wherein the campaign zone information comprises location information based on a geographical location of the mobile device.

9. A system comprising:
a processor; and
a memory structure coupled with the processor, the memory structure being configured to store campaign related data,
wherein the processor is configured to perform operations comprising:
providing a graphical user interface to create a campaign zone for a location, create campaign messages for the campaign zone, prioritize the campaign messages, and produce campaign message priority information, wherein the graphical user interface is configured to specify for a campaign message a beacon identifier associated with a beacon device that is within a vicinity of the location, and to specify for the campaign message an action for a mobile device to perform in response to receiving a beacon message containing the beacon identifier from the beacon device;
generating campaign information based on the campaign messages and the campaign message priority information;
storing the campaign information in the memory structure; and
providing the campaign information to mobile devices.

10. The system of claim 9, wherein providing the campaign information to the mobile devices comprises sending the campaign information to an application running on the mobile device, wherein the campaign information controls how the application presents one or more of the campaign messages in response to receiving one or more beacon messages that are associated with the campaign zone.

11. The system of claim 9, wherein the campaign information controls a presentation order of two or more of the campaign messages in response to receiving multiple different beacon messages that are associated with the campaign zone.

12. The system of claim 9, wherein the graphical user interface comprises an interface to specify for the campaign message one or more first level criteria for determining whether to present a campaign message parameter, and wherein the campaign message priority information comprises one or more second level criteria to resolve a tie if two or more of the campaign messages qualify for presentation based on respective one or more first level criteria.

13. The system of claim 9, wherein the campaign information comprises one or more campaign message records, and wherein the one or more campaign message records comprise a beacon identifier parameter corresponding to the beacon identifier, an action type parameter corresponding to the action, a proximity threshold parameter, message frequency parameter, and message content parameter.

14. The system of claim 9, wherein the operations comprise:
receiving campaign zone information from the mobile device;
identifying a campaign zone that corresponds to the campaign zone information;
retrieving campaign information corresponding to the identified campaign zone; and
sending the retrieved campaign information to the mobile device.

15. The system of claim 14, wherein the campaign zone information comprises a detected beacon identifier that is detected by the mobile device.

16. The system of claim 14, wherein the campaign zone information comprises location information based on a geographical location of the mobile device.

17. A method comprising:
determining, at a mobile device, campaign zone information associated with a location;
sending, from the mobile device, the campaign zone information to a server;
receiving, at the mobile device, a campaign file that corresponds to the campaign zone information, the campaign file comprising campaign messages;
receiving, at the mobile device, beacon messages from multiple beacon devices over short-range communication links, the beacon devices being within a vicinity of the location;
determining priorities of the beacon messages based on the campaign file;
selecting a beacon message of the beacon messages based on the priorities to produce a selected beacon message; and
presenting a campaign message of the campaign messages that corresponds to the selected beacon message through the mobile device.

18. The method of claim 17, wherein the campaign zone information comprises a detected beacon identifier that is detected by the mobile device.

19. The method of claim 17, wherein the campaign zone information comprises location information based on a geographical location of the mobile device.

20. A mobile device comprising:
circuitry configured to receive beacon messages from multiple beacon devices over short-range communication links, the beacon devices being within a vicinity of a location; and
a processor coupled with the circuitry, wherein the processor is configured to perform operations comprising:
determining campaign zone information associated with the location;
sending the campaign zone information to a server;
receiving a campaign file that corresponds to the campaign zone information, the campaign file comprising campaign messages;
determining priorities of the beacon messages based on the campaign file;
selecting a beacon message of the beacon messages based on the priorities to produce a selected beacon message; and
presenting a campaign message of the campaign messages that corresponds to the selected beacon message through the mobile device.

21. The mobile device of claim 20, wherein the campaign zone information comprises a detected beacon identifier that is detected by the mobile device.

22. The mobile device of claim 20, wherein the campaign zone information comprises location information based on a geographical location of the mobile device.
